(19) United States
(12) Patent Application Publication
(10) Pub. No.: US 2006/0109572 A1
(43) Pub. Date: May 25, 2006

(54) MIRROR A-PILLAR MOUNTING BRACKET ASSEMBLY

(75) Inventors: William Schmidt, Newport, MI (US); Daniel M. Swain, Wyandotte, MI (US)

Correspondence Address: ARTZ & ARTZ, P.C., 28333 TELEGRAPH RD., SUITE 250, SOUTHFIELD, MI, 48034, US

(73) Assignee: MIRROR LITE, Rockwood, MI (US)

(21) Appl. No.: 10/904,721

(22) Filed: Nov. 24, 2004

(51) Int. Cl. G02B 5/08

(52) U.S. Cl. 359/871; 359/879

(57) ABSTRACT

A vehicle mirror assembly 10 is provided. The vehicle mirror assembly 10 includes a triangular mounting plate 24 adapted to mate with the base of a vehicle a-pillar 26. The triangular mounting plate 24 includes an inner surface 56 and an outer surface 58. At least one attachment element 60 is mounted on the inner surface 56. The vehicle mirror assembly 10 further includes an elongated support member 28 having a vehicle end 34 and a mirror end 36. The vehicle end 34 is rotatably attached to the outer surface 58. A mirror housing 30 is attached to the mirror end 36.

### TECHNICAL FIELD

The present invention relates generally to an exterior automotive mirror mounting assembly, and, more particularly to a mounting assembly with improved mounting and line-of-sight characteristics.

### BACKGROUND OF THE INVENTION

Automotive mirror assemblies can play a vital role in vehicle operation. Placement of the vehicle operator within the vehicle structure often makes direct line-of-sight to surrounding vehicle areas impractical. Yet such visual inspections of surrounding areas can provide the vehicle operator with information necessary for proper vehicle operation. As vehicle size increases, so often does the difficulty of accurate visual inspections. Vehicles, such as school buses, trucks, and vans often utilize increased vehicle sizes while requiring visual inspection of areas in front of and to the side of the vehicle. To this end, it is well known that vehicle mirrors may be front-end mounted to the vehicle to provide the widest possible field of view around the vehicle.

The operator's field of view has been improved through the use of convex mirrors. By increasing the size of the convex mirror, it was discovered that the field of view could be increased. The size of the convex mirror, however, becomes limited as the mirror itself can begin to become an obstruction to forward viewing. Proper sizing and positioning of the mirror, therefore, can become critical to the dual purposes of increasing field of view while minimizing the obstruction of direct line-of-sight lines. Proper positioning requires that the mirrors must typically be mounted in positions substantially elevated from the physical structure of the vehicle. This allows the mirrors to properly generate the desired line-of-sight lines with respect to the operator in the driver's seat of the vehicle. In order to accommodate these requirements, it is common for mounting bracket structure to be mounted to the hood or side of the vehicle in order to support the mirror in the desired location. The bracket structures, themselves often create obstructions to forward viewing. Attempts, therefore, have been made to minimize the bracketing structures in order to minimize their impact on obstructed viewing.

An important aspect of the bracketing structures, however, is that they must support the mirror in its desired location while being subjected to continuous vibrations and impacts during routine operation of the vehicle. This environmental loading has commonly run counter to the minimization of the bracketing structures. The structures are commonly built to be robust and resistant to vibration and therefore often lead to large cross section members and/or a multitude of attachment arms. Both of these design directives can lead to an increase in obstructed view sight lines. A departure from standard design practice, wherein robustness must be sacrificed for a reduction in obstructive view, is needed to provide improvements to mirror assemblies and their respective mounting assemblies.

It would, therefore, be highly desirable to have a mirror mounting bracket assembly that provides a robust support for a mirror assembly. It would further be highly desirable to have a mirror mounting bracket assembly that reduces the generation of obstructive line-of-sight views.

### SUMMARY OF THE INVENTION

A vehicle mirror assembly is provided. The vehicle mirror assembly includes a triangular mounting plate adapted to mate with the base of a vehicle a-pillar. The triangular mounting plate includes an inner surface and an outer surface. At least one attachment element is mounted on the inner surface. The vehicle mirror assembly further includes an elongated support member having a vehicle end and a mirror end. The vehicle end is rotatably attached to the outer surface. A mirror housing is attached to the mirror end.

Other features of the present invention will become apparent when viewed in light of the detailed description of the preferred embodiment when taken in conjunction with the attached drawings and appended claims.

### BRIEF DESCRIPTION OF THE DRAWINGS

FIG. 1 is an isometric passenger side view of a van illustrating a vehicle mirror assembly in accordance with the present invention.

FIG. 2 is a detailed view of the passenger side vehicle mirror assembly illustrated in FIG. 1.

FIG. 3 is a front view detail of the passenger side vehicle mirror assembly illustrated in FIG. 2.

FIG. 4 is an isometric driver's side view of a van illustrating a vehicle mirror assembly in accordance with the present invention.

FIG. 5 is a front view detail of the driver's side vehicle mirror assembly illustrated in FIG. 4.

FIG. 6 is a front view detail of a mounting plate for use the in vehicle mirror assembly illustrated in FIGS. 1 through 5.

FIG. 7 is a top view detail of the mounting plate illustrated in FIG. 6.

FIG. 8 is a side view detail of the mounting plate illustrated in FIG. 6.

FIG. 9 is a rear view detail of the mounting plate illustrated in FIG. 6.

FIG. 10 is an isometric passenger side view of an a-style bus illustrating the vehicle mirror assembly illustrated in FIG. 1.

### DESCRIPTION OF THE PREFERRED EMBODIMENT(S)

Referring now to FIG. 1, which is a vehicle mirror assembly 10 in accordance with the present invention. The vehicle mirror assembly 10 is illustrated mounted on a vehicle 12, namely an A-Style bus. Oversized vehicles, such as the A-style bus, present unique problems to driver viewing. A driver is positioned within the cab section 14 of the vehicle 12. In order for a driver to properly scan the perimeter of the vehicle 12, however, the driver must utilize mirror assemblies 10 mounted to the vehicle surface 16. These mirror assemblies 10 must often provide such a field of view around the body portion 18 of the vehicle 12 positioned in an aft direction 20 of the cab 14. When the body portion 18 extends away from the cab 14 in an outboard direction 22, such as is the case with an A-style bus, the mirror assembly 10 must be positioned substantially away from the vehicle surface 16 in order to afford the driver such a field of view. In order to accommodate this positioning, a stable mounting assembly that minimizes direct line-of-sight blockage is preferable.

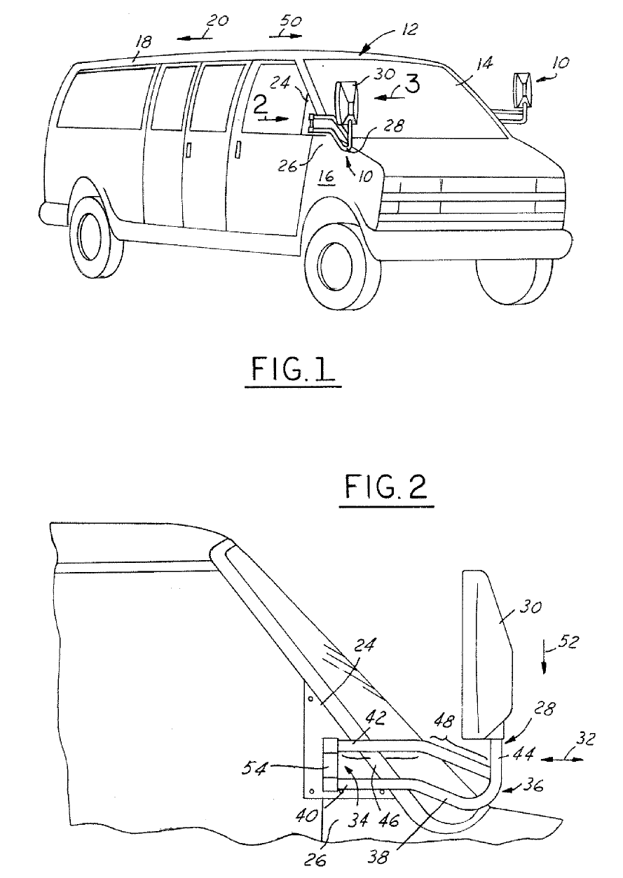

The present invention addresses these concerns by providing a unique and novel vehicle mirror assembly 10 that provides such as stable mounting while minimizing the profile of the mounting hardware. The vehicle mirror assembly 10 includes a mounting plate 24 adapted to mate with the base of the vehicle a-pillar 26. The mounting plate 24 provides a secure platform for which to mount an elongated support member 28 on which is mounted the mirror housing 30. A detailed description of the mounting plate 24 will be provided subsequently. The elongated support member 28 extends horizontally 32 from a vehicle end 34 to a mirror end 36. The vehicle end 34 is preferably rotatably mounted to the mounting plate 24 such that the mirror housing 30 can be adjusted in the outboard direction 22 in order to provide an optimal field-of-view to the driver. Although this rotatable mount may be configured in a variety of ways, one embodiment illustrated in FIG. 2 contemplates the use of a hinge element 54 mounted to the mounting plate 24 and in communication with the elongated support member 28. An important aspect of the present invention stems from the elongated support member 28 extending from the base of the vehicle a-pillar 26. By extending from this position, the elongated support member 28 generates an improved profile that minimizes obstruction of direct line-of-sight views. In addition, by utilizing the base of the vehicle a-pillar 26 the present invention can be conveniently retrofitted onto many vehicles.

Although a wide variety of elongated support members 28 are contemplated, one embodiment is illustrated in FIG. 2. The embodiment illustrated is optimize for the passenger side of an A-style bus, although would be suitable in any number of applications. The elongated support member 28 is comprised of at least one tubular arm member 38 extending horizontally from the mounting plate 24. Specifically, the elongated support member 28 is comprised of a lower tubular arm 40 and an upper tubular arm 42 extending parallel to one another from the mounting plate 24. At the mirror end 36 they are joined to a vertical tubular arm 44 that extends up vertically to support the mirror housing 30. Although the vertical tubular arm 44 may be comprised of an independent arm mounted to the lower tubular arm 40 and the upper tubular arm 42, it is contemplated that in one embodiment the lower tubular arm 40 may be curved upwards at the mirror end 36 to form the vertical tubular arm 44. In this embodiment the upper tubular arm 42 can be terminated into and mounted to the vertical tubular arm 44 to create a robust elongated support structure for the mirror housing 30. The mirror housing 30 is preferably rotatably mounted to the vertical tubular arm 44 such that further optimization of viewing angles is available.

Although the elongated support member 28 may simply extend horizontally as preferred in the driver's side assembly illustrated in FIGS. 4 and 5, it is contemplated that additional enhancements may be implemented. The passenger side assembly illustrated in FIGS. 1 and 2 illustrates some of these enhancements. The elongated support member 28 in this configuration is comprises of a horizontal portion 46 and a compound bend portion 48. The horizontal portion 46 extends from the mounting plate 24 in primarily a horizontal fore direction 50 (subject to the rotational position of the elongated support member 28). The compound bend portion 48, however, extends the elongated support member 28 in a downward direction 52 as well as an outboard direction 22. This allows the mirror housing 30 to be positioned for viewing past the body portion 18 of the vehicle 12 while providing even further improvements to the driver's direct line-of-sight. Although two particular directions have been described in illustrating the compound bend portion 48, it should be understood that a wide variety of directions may be utilized as would be dictated by vehicle 12 structures and relative positioning of the a-pillar 26.

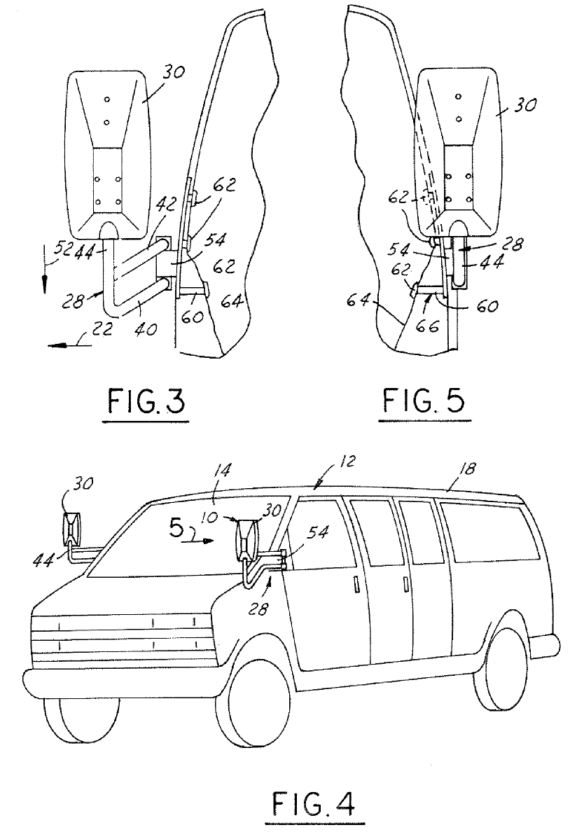

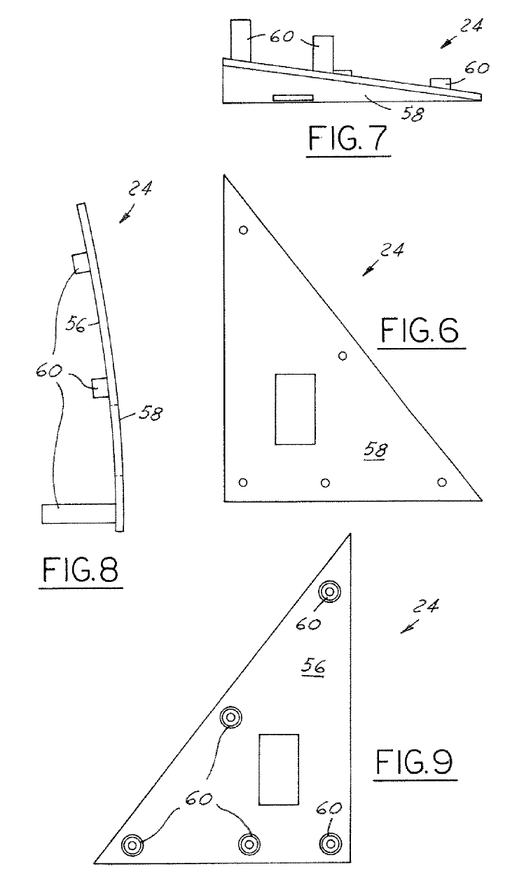

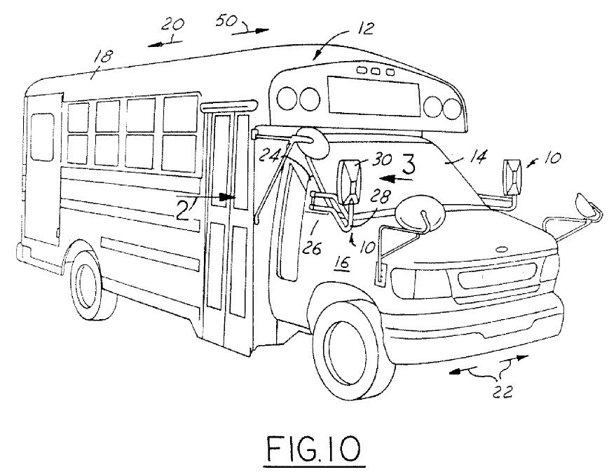

As previously discussed, the mounting plate 24 is adapted to mate with the base of the vehicle a-pillar 26. One embodiment of the mounting plate 24 is illustrated in FIGS. 6 through 9. The mounting plate 24 design provides significant advantages to the present invention as it allows simple and effective retrofitting of present vehicles 12 to utilized the present design. The mounting plate 24 is preferably triangular in shape so as to conform with existing a-pillar 26 bases. The mounting plate 24 includes an inner surface 56 and an outer surface 58. The inner surface 56 is preferably concave so as to conform to existing a-pillar designs. A plurality of attachment elements 60 are mounted to the inner surface 56 preferably positioned around the periphery of the mounting plate 24. These attachment elements 60 are configured to extend through the base of the a-pillar 26 as illustrated in FIGS. 3 and 5. In this fashion they allow the mounting plate 24 to be secured to the a-pillar 26 by way of mounting caps 62 affixed to the attachment elements 60 and in communication with the inner vehicle a-pillar surface 64. Thus the present invention may be installed onto any existing vehicle 12 through only the simple process of drilling mounting holes 66 through the a-pillar 26. It should be understood that the number and dimensions of the attachment elements 60 may be varied to maximize rigidity of the vehicle mirror assembly 10 while retaining desired structural characteristics of the a-pillar 26.

While particular embodiments of the invention have been shown and described, numerous variations and alternative embodiments will occur to those skilled in the arm. Accordingly, it is intended that the invention be limited only in terms of the appended claims.

What is claimed is:

1. A vehicle mirror assembly for mounting to the base of a vehicle a-pillar comprising:
a triangular mounting plate adapted to mate with the base of the vehicle a-pillar, said triangular mounting plate having an inner surface and an outer surface;
at least one attachment element mounted to said inner surface;
an elongated support member having a vehicle end and a mirror end, said vehicle end rotatably attached to said outer surface, said mirror end extending away from the vehicle a-pillar; and
a mirror housing mounted to said mirror end.

2. A vehicle mirror assembly as described in claim 1, wherein said inner surface comprises a concave inner surface.

3. A vehicle mirror assembly as described in claim 1, wherein said elongated support member comprises at least one tubular arm member extending horizontally from said vehicle end.

4. A vehicle mirror assembly as described in claim 1, wherein said elongated support member comprises an upper tubular arm member and a lower tubular arm member, said upper tubular arm member and said lower tubular arm member extending parallel to each other from said vehicle end to said mirror end.

5. A vehicle mirror assembly as described in claim 4, wherein said elongated support member further comprises a vertical tubular arm member mounted to said upper tubular arm member and said lower tubular arm member at said mirror end, said mirror housing mounted to said vertical tubular arm.

6. A vehicle mirror assembly as described in claim 5, wherein said lower tubular arm is curved at said mirror end to form said vertical tubular arm.

7. A vehicle mirror assembly as described in claim 1, wherein said elongated support member comprises a horizontal portion and a compound bend portion.

8. A vehicle mirror assembly as described in claim 7, wherein said compound bend portion bends in an outboard direction.

9. A vehicle mirror assembly as described in claim 7, wherein said compound bend portion bends in a downward direction.

10. A vehicle mirror assembly as described in claim 7, wherein said compound bend portion bends in a downward direction and an outboard direction.

11. A vehicle mirror assembly for mounting to the base of a vehicle a-pillar on the cab section of a bus, the vehicle including a body portion extending outboard of the cab section, the vehicle mirror assembly comprising:
a mounting plate adapted to mate with the base of the vehicle a-pillar, said mounting plate having an inner surface and an outer surface;
at least one attachment element mounted to said inner surface and extending through the vehicle a-pillar to secure said mounting plate to the vehicle a-pillar;
an elongated support member having a vehicle end and a mirror end, said vehicle end rotatably attached to said outer surface, said mirror end extending away from the vehicle a-pillar; and
a mirror housing mounted to said mirror end.

12. A vehicle mirror assembly as described in claim 11, further comprising:
at least one hinge element attaching said elongated support member to said outer surface.

13. A vehicle mirror assembly as described in claim 11, wherein said elongated support member comprises a horizontal portion extending in a fore direction from the vehicle a-pillar, said horizontal portion attaching to said outer surface.

14. A vehicle mirror assembly as described in claim 13, wherein said elongated support member further comprises a compound bend portion attached to said horizontal portion, said compound bend portion extending in an outboard direction and a downward direction such that said mirror housing provides a field of view past the body portion of the bus.

15. A vehicle mirror assembly as described in claim 11, wherein said elongated support member comprises an upper tubular arm member, a lower tubular arm member, and a vertical tubular arm member, said upper tubular arm member and said lower tubular arm member extending parallel to each other from said vehicle end to said mirror end.

16. A vehicle mirror assembly as described in claim 15, wherein said lower tubular arm is curved at said mirror end to form said vertical tubular arm.

17. A method of mounting a vehicle mirror assembly to the base of a vehicle a-pillar on the cab section of a vehicle comprising:
mounting a mounting plate to the base of the vehicle a-pillar, said mounting plate formed with a concave inner surface to conform to the vehicle a-pillar;
pivotably mounting an elongated support member to said mounting plate such that said elongated support member extends in a fore direction from the vehicle a-pillar;
mounting a mirror housing to a mirror end of said elongated support member.

18. A method of mounting a vehicle mirror assembly to the base of a vehicle a-pillar on the cab section of a vehicle as described in claim 17, further comprising:
bending said elongated support member such that said elongated support member extends in a downward direction and an outboard direction from the vehicle a-pillar.

19. A method of mounting a vehicle mirror assembly to the base of a vehicle a-pillar on the cab section of a vehicle as described in claim 17, further comprising:
inserting at least one attachment element, mounted to said mounting plate, through the vehicle a-pillar; and
securing said at least one attachment element to the inner vehicle a-pillar surface.
